(19) United States
(12) Patent Application Publication
(10) Pub. No.: US 2022/0011450 A1
(43) Pub. Date: Jan. 13, 2022

(54) Systems and Methods for Shutterless Afterglow Measurement

(71) Applicant: OSI Optoelectronics, Inc., Hawthorne, CA (US)

(72) Inventor: Mitch Agamohamadi, Orange, CA (US)

(21) Appl. No.: 16/927,731

(22) Filed: Jul. 13, 2020

(51) Int. Cl. G01T 1/20

(52) U.S. Cl. CPC G01T 1/20184; G01T 1/2006; G01T 1/20186; G01T 1/20185

(57) ABSTRACT

The present specification discloses a system that employs a shutter-less method of measuring afterglow, in which the start and termination of the stimulating radiation from the radiation source is controlled electronically. A fast decay scintillator may be used in the beam path to monitor and track the rise and fall of the stimulating radiation to determine the dose and full cessation of the stimulating radiation. This information is used to calculate the afterglow for a slow decay scintillator. This method can also be used to calibrate and normalize scanned image data and produce an enhanced image. The fast decay scintillator is used as a monitoring or tracking device to be able to determine radiation source decay.

### FIELD

The present specification generally relates to systems for scanning objects using X-rays, and more specifically to a system that uses a shutterless method for measuring an afterglow of scintillators used in X-ray imaging machines.

### BACKGROUND

Scintillators are important components employed in imaging arrays used in medical and security scanners, and are commonly used as detectors in scanning systems. Scintillators are characterized by their conversion efficiency (photons/MeV), scintillation decay time, density, chemical stability, and afterglow. Afterglow is defined as the percentage luminescence intensity that remains for a prescribed time (e.g. 10 ms) after switching off the source of incident energetic radiation, such as neutrons or X-rays. Determining an amount of afterglow, and then minimizing or correcting that afterglow, is required for scans involving a rapidly changing field of view, otherwise a form of ‘ghosting’ is observed. Motion-related artifacts in radiological digital images can hinder security inspections as well as medical diagnoses.

An afterglow component is typically left after termination of sustained stimulating radiation incident on a scintillator. The prompt luminescent response falls rapidly to zero leaving an afterglow with a notably slower decay time. Given that afterglow builds up over tens or hundreds of milliseconds, the duration of the radiation pulse used and the method of afterglow measurement can influence the measured value of the afterglow. Therefore, for a given scintillator, comparisons with the afterglow measured for standard scintillators are important. In addition, afterglow measurements are essential for testing the performance and imaging capacity of scintillator detectors. The existing method of measuring afterglow employed in many scanning systems uses a mechanical lead shutter to block the stimulating radiation or X-ray beam that has been on for a finite amount of time, thus directing a specific dose of stimulating radiation toward and into the scintillators. The afterglow is measured immediately following the closure of the shutter. The time it takes to effectuate shutter closure can introduce error into the afterglow readings. Further, the shutter closure time can vary depending on normal wear and variations in environmental and operational parameters of the shutter mechanism over time that can effect performance and production schedules. Therefore, shutter error cannot be reliably quantified and factored into measurement.

Moreover, the shutter is a mechanical, moving part that requires routine maintenance which can be time consuming and expensive. Since the shutter is a pneumatically driven mechanical component, it is prone to failure as it has to rapidly close and open during measurements. Most shutters also have lead pieces for blocking the beam, which are difficult to maintain and keep in position within the shutter.

There is therefore a need for methods and systems for afterglow measurement that do not require mechanical parts, yet are capable of measuring and quantifying the afterglow with accuracy. There is also a need for methods and systems for afterglow measurement that can respond rapidly on the time scales of radiation emission and termination.

### SUMMARY

The following embodiments and aspects thereof are described and illustrated in conjunction with systems, tools and methods, which are meant to be exemplary and illustrative, and not limiting in scope. The present application discloses numerous embodiments.

The present specification discloses a method for measuring radiation afterglow for a first detector comprising a slow decay scintillator coupled to a first photodiode, said method comprising: providing a second detector comprising a fast decay scintillator coupled to a second photodiode; placing said first and said second detectors in the path of a radiation beam generated by a radiation source; using electronic means for switching on said radiation source; using an electrical circuit in contact with said first and said second detectors to produce a first and a second electrical signal corresponding to the detected radiation; using electronic means for switching off said radiation source; determining a first point in time when the second detector comprising said fast decay scintillator detects complete cessation of radiation; and measuring the detected radiation level for the first detector comprising said slow decay scintillator from said first point in time till the point in time when said first detector detects complete cessation of radiation.

Optionally, the radiation source is turned on for a time duration ranging from 0.1 to 30 seconds.

Optionally, a duration for which the radiation source is turned on is dependent upon the slow decay scintillator's fast and slow decay time constants.

Optionally, a duration for which the radiation source is turned on is dependent upon the slow decay scintillator's type and formulation.

Optionally, the slow decay scintillator in said first detector exhibits 10% afterglow in a response time ranging from 0.1 to 10 ms.

Optionally, the fast decay scintillator in said second detector exhibits 10% afterglow in a response time ranging from 0.1 to 10 ms.

Optionally, the complete cessation of radiation is determined from the electrical signals generated by the corresponding detectors. Optionally, an electrical circuit in contact with said first and said second detectors produces the first electrical signal and a second electrical signal corresponding to the detected radiation respectively.

The present specification also discloses a system for measuring radiation afterglow for a first detector comprising a slow decay scintillator coupled to a first photodiode, the system comprising: a second detector comprising a fast decay scintillator coupled to a second photodiode; a radiation source for generating a radiation beam which irradiates said first and said second detectors; electronic means for switching the said radiation source on or off; an electrical circuit in contact with said first and said second detectors to produce a first electrical signal and a second electrical signal corresponding to the detected radiation; and measurement means for measuring the first electrical signal for said first detector from the point in time when the second detector detects complete cessation of radiation till the point in time when said first detector detects complete cessation of radiation.

Optionally, the measured first electrical signal is used for obtaining the radiation afterglow for the first detector.

Optionally, the electrical circuit in contact with said first and said second detectors is provided on a circuit board having a first top side in contact with the first detector and a second opposing bottom side in contact with the second detector. Optionally, the radiation beam passes through the circuit board to irradiate the second detector.

Optionally, a duration for which the radiation source is turned on is dependent upon the slow decay scintillator's fast and slow decay time constants.

Optionally, a duration for which the radiation source is turned on is dependent upon the slow decay scintillator's type and formulation.

Optionally, the radiation source is turned on for a time duration ranging from 0.1 to 30 seconds Optionally, the slow decay scintillator in said first detector exhibits 10% afterglow in a response time ranging from 0.1 to 10 ms.

Optionally, the fast decay scintillator in said second detector exhibits 1% afterglow in a response time ranging from 0.1 to 10 ms.

Optionally, the complete cessation of radiation is determined from the electrical signals generated by the corresponding detectors.

Optionally, the second detector is positioned below the first detector in a funnel configuration.

Optionally, the second detector is positioned at a side of the first detector in a parallel configuration.

The present specification also discloses a method of calibrating scan images of an object being scanned by using a scanning system comprising at least a radiation source and a detector, the detector comprising a fast scintillator coupled with a photodiode, the method comprising: turning on the radiation source to measure a full intensity of unobstructed light level detected by the detector; turning off the radiation source to measure a dark signal intensity comprising an afterglow signal detected by the detector; normalizing the measured afterglow signal by subtracting the measured dark signal intensity from the measured full intensity of unobstructed light signal intensity; and, obtaining calibrated scan images.

Optionally, the calibrated scan images have a resolution greater than a resolution of uncalibrated scan images.

Optionally, the radiation source has an energy ranging from 50 kV to 300 kV and power ranging from 0.5 mA to 10 mA.

Optionally, the dark signal intensity comprises a photodiode dark current.

Optionally, normalizing the measured afterglow signal is performed in-situ with the detectors remaining in place in the scanning system; Optionally, normalizing the measured afterglow signal is performed in-process during the operation of the scanning system in real time.

Optionally, the calibrated scanned images have a greater contrast characteristic than a contrast characteristic of uncalibrated scanned images.

The aforementioned and other embodiments of the present specification shall be described in greater depth in the drawings and detailed description provided below.

### BRIEF DESCRIPTION OF THE DRAWINGS

These and other features and advantages of the present specification will be appreciated, as they become better understood by reference to the following detailed description when considered in connection with the accompanying drawings, wherein:

FIG. 1A is a schematic illustration of a conventional afterglow measurement system, wherein a mechanical shutter is in an open position;

FIG. 1B is a schematic illustration of a conventional afterglow measurement system, wherein a mechanical shutter is in a closed position;

FIG. 2 illustrates a conventional system assembly for measuring afterglow;

FIG. 3 is a plot representing a decay curve for afterglow levels versus time, for the system and methods described in FIGS. 1A, 1B and 2;

FIG. 4A is a schematic illustration of a system for measuring afterglow, in accordance with an embodiment of the present specification;

FIG. 4B is a schematic illustration of a system for measuring afterglow, in accordance with an embodiment of the present specification;

FIG. 5A is a plot showing afterglow detection using a combination of slow and fast decay scintillators, according to an embodiment of the present specification;

FIG. 5B is a flowchart illustrating a method for measuring afterglow, in accordance with an embodiment of the present specification;

FIG. 6 illustrates a system assembly for measuring afterglow, in accordance with an embodiment of the present specification;

FIG. 7 is an exploded break-away view of the system assembly for measuring afterglow, as shown in FIG. 6, in accordance with an embodiment of the present specification;

FIG. 8A is a plot generated by using a conventional “mechanical shutter” method for measuring afterglow;

FIG. 8B is a plot generated by using a shutterless method for measuring afterglow, in accordance with the present specification;

FIG. 9A is an exemplary image showing an effect of afterglow;

FIG. 9B is another exemplary image showing an effect of afterglow; and

FIG. 10 is a flowchart illustrating a method of calibrating a scanned image by calibrating afterglow measurement data of the scanned image, in an embodiment of the present specification.

### DETAILED DESCRIPTION

In an embodiment, the present specification discloses a system that employs a shutterless method of measuring afterglow, in which the start and termination of the stimulating radiation or X-rays are controlled electronically at the source or the generator level. In an embodiment, a fast decay scintillator is used in the beam path to monitor and track the rise and fall of the stimulating radiation or X-rays to determine the dose and full cessation of the stimulating radiation or X-rays, which can be used to calculate the afterglow of a slow decay scintillator. The fast decay scintillator is used as a monitoring or tracking device to determine or compensate for radiation source decay. This method can also be used to calibrate and normalize scanned image data to produce an enhanced image.

The present specification discloses multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present specification is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

In the description and claims of the application, each of the words “comprise” “include” and “have”, and forms thereof, are not necessarily limited to members in a list with which the words may be associated. It should be noted herein that any feature or component described in association with a specific embodiment may be used and implemented with any other embodiment unless clearly indicated otherwise.

In addition, one of ordinary skill in the art would appreciate that the features described in the present application can operate on any computing platform including, but not limited to: a laptop or tablet computer; personal computer; personal data assistant; cell phone; server; embedded processor; digital signal processor (DSP) chip or specialized imaging device capable of executing programmatic instructions or code. It should further be appreciated that the platform provides the functions described in the present application by executing a plurality of programmatic instructions, which are stored in one or more non-volatile memories, using one or more processors and presents and/or receives data through transceivers in data communication with one or more wired or wireless networks. It should further be appreciated that each device has wireless and wired receivers and transmitters capable of sending and transmitting data, at least one processor capable of processing programmatic instructions, memory capable of storing programmatic instructions, and software comprised of a plurality of programmatic instructions for performing the processes described herein. Additionally, the programmatic code can be compiled (either pre-compiled or compiled “just-in-time”) into a single application executing on a single computer, or distributed among several different computers operating locally or remotely to each other.

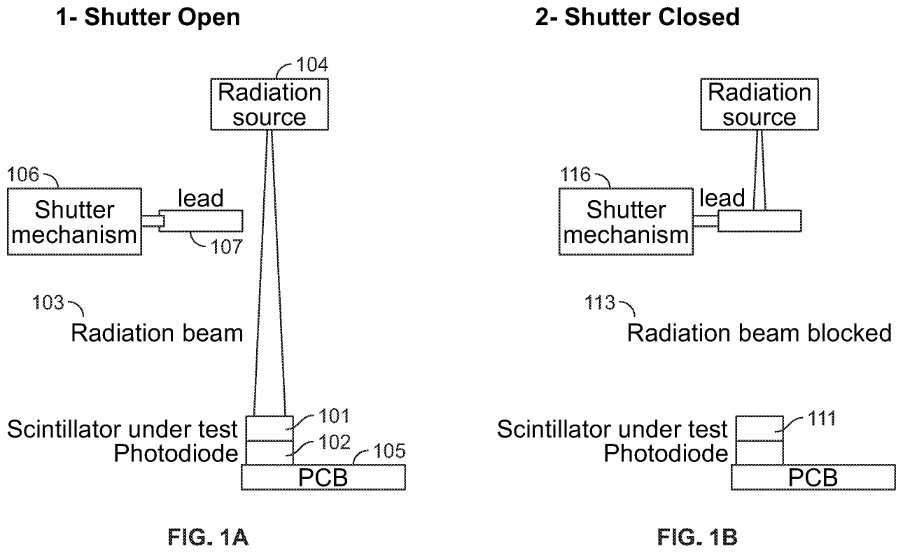

FIGS. 1A and 1B provide a schematic illustration of a conventional afterglow measurement system. Referring to FIG. 1A, a scintillator 101 is optically coupled to a photodiode 102 and placed in the path of a radiation beam 103 from radiation source 104. The radiation detected by the scintillator-photodiode pair is converted to an electrical signal using a PCB 105. A shutter mechanism 106 comprising a lead block 107 is placed in the path of the beam 103. Shutter 106 is opened to expose the scintillator to stimulating radiation, as shown in FIG. 1A. Referring to FIG. 1B, the shutter mechanism 116 is closed, blocking the radiation beam 113 from impinging upon the scintillator 111. The resultant afterglow is subsequently measured.

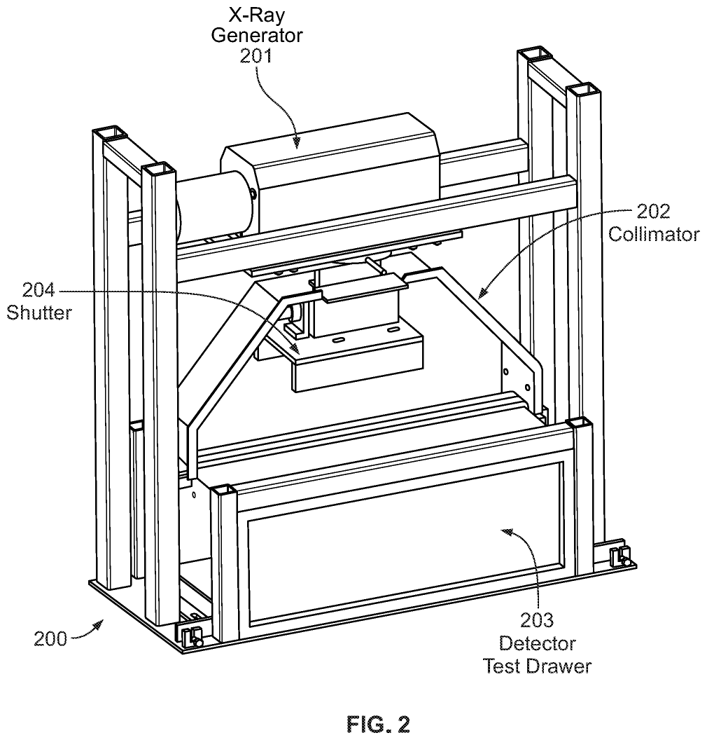

FIG. 2 illustrates a system assembly for measuring afterglow using the system as described with reference to FIGS. 1A and 1B. Referring to FIG. 2, system 200 comprises a radiation source, such as an X-ray generator 201 and a collimator 202 for directing a radiation beam from the source 201 to a detector 203. A shutter mechanism 204 is provided, which in this case is coupled to the collimator assembly 202. The shutter mechanism 204 is in an open position to allow a radiation beam to pass through to the detector 203 and is in a closed position to block a radiation beam from impinging upon the detector 203, thus enabling afterglow to be measured. In embodiments, the detector 203 includes at least one scintillator-photodiode pair.

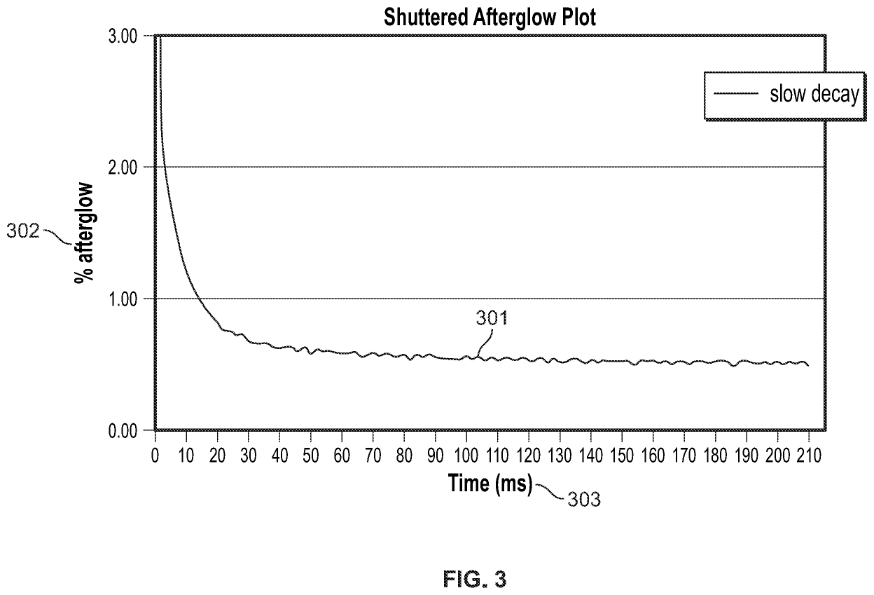

FIG. 3 is a plot representing a decay curve 301 for afterglow levels 302 versus time 303, following a shutter closure using the system and methods described in FIGS. 1A, 1B and 2. It should be noted that plot 301 represents decay curve for a slow decay scintillator, wherein the afterglow decays to below 1% in milliseconds.

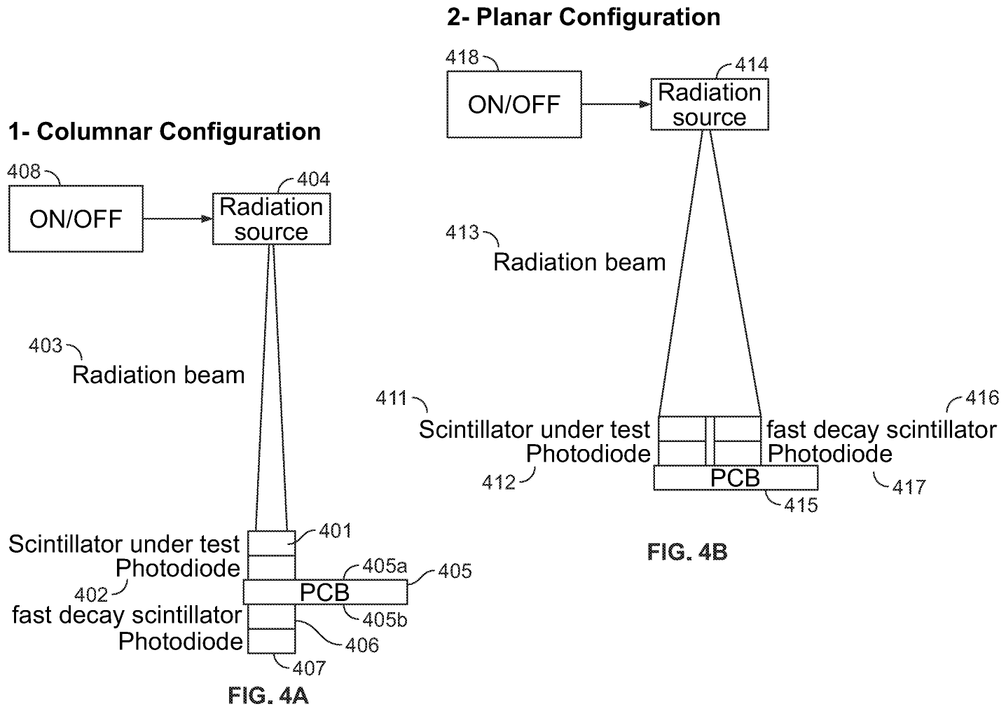

FIGS. 4A and 4B provide a schematic illustration of a system for afterglow measurement, in accordance with one embodiment of the present specification. As is known, visible light photons emitted by a scintillator in response to stimulating radiation or by recombining of hole-electron pairs, are absorbed by a photodiode coupled with the scintillator and converted into electrons resulting in a current flow. It should be noted that FIG. 4A illustrates a columnar configuration of a slow decay scintillator and a fast decay scintillator for purposes of an afterglow measurement. Referring to FIG. 4A, a first scintillator 401 is coupled to a first photodiode 402 and placed in the path of a radiation beam 403 generated from a radiation source 404. The radiation source 404 may be an X-ray source or any other source for generating a beam of radiation. In one embodiment, the scintillator 401 is a slow decay scintillator. In embodiments, the slow decay scintillator has a slow decay time ranging between 100 microseconds to 100 milliseconds. The radiation detected by the first scintillator 401 and first photodiode 402 pair is converted to an electrical signal using an electrical circuit on a PCB 405. In one embodiment, the first photodiode 402 is coupled to a first, top side 405a of the PCB 405, wherein the first, top side 405a faces the radiation source 404. A sensor 406, which in one embodiment is a fast decay scintillator, is positioned on the opposite side or bottom side 405b of the PCB 405 and is coupled to a second photodiode 407. In embodiments, the fast decay scintillator has a fast decay time ranging between multiples of 10 nanoseconds to multiples of 10 microseconds. In embodiments, during fast decay, a light signal intensity typically decays from 100% to approximately 3%. In embodiments, the slow decay scintillator has a decay time ranging between multiples of 100 microseconds to multiples of 100 milliseconds. In embodiments, during slow decay, a light signal intensity typically decays in an amount ranging from 1% to 3%. In various embodiments, the decay time of the slow scintillator is approximately 1000 times more than the decay time of the fast scintillator.

An electronic mechanism 408 is configured to turn on the radiation source 404 to expose the scintillator 401 to radiation 403, or to turn off the radiation source 404 to stop the path of stimulating radiation 403 and thus measure the afterglow. In an embodiment, electronic mechanism 408, when activated, provides an instantaneous command to turn on or off the source 404, however, the actual output of the radiation source 404 takes approximately 50-200 milliseconds to rise and fall. In an embodiment, the electronic mechanism 408 comprises an electronic signal such as, but not limited to, a transistor-transistor logic (TTL) signal generated by a software algorithm and controlled by a signal controller for turning the source 404 on or off. As an example, X-ray generators having an energy ranging from 50 kV to 300 kV and power ranging from 0.5 mA to 10 mA take approximately 50-200 milliseconds to rise and then fall. In an embodiment, the output of the radiation source 404 takes one or more microseconds to rise and fall. In various embodiments, the source 404 is kept on or off depending upon on the slow decay scintillator's 401 fast and slow decay time constants. In an embodiment, the source 404 is turned on for 10-20 seconds and then turned off, and afterglow is measured immediately after. For example, the afterglow may be measured at 20, 50, 100, 200 and 500 ms. Once the radiation source is turned off, the fast decay sensor 406 tracks the radiation source 404 as it falls, while the slow decay scintillator 401 lags in detection. In various embodiments, the radiation beam 403 passes through the PCB 405 and impinges on the fast decay sensor 406. Since fast decay sensors such as fast decay scintillators 406 respond to stimulating radiation in nano or micro seconds as known in the art, they can track the rise and fall of the slow radiation sources that take milliseconds to rise and milliseconds to fall. In an embodiment, after the full cessation of stimulating radiation is determined by fast decay sensor 406, the afterglow of the slow decay scintillator 401 is measured. Thus, the present specification uses a fast decay sensor/scintillator 406 as a monitoring or tracking device to be able to determine the decay time of the radiation source 404.

FIG. 4B illustrates another arrangement of how a slow decay sensor/scintillator and a fast decay sensor/scintillator may be positioned for afterglow measurement. This arrangement is known as a planar configuration, in accordance with an embodiment. Referring now to FIG. 4B, a scintillator 411 is coupled to a first photodiode 412 and placed in the path of a radiation beam 413 emitted from radiation source 414. In one embodiment, the scintillator 411 is a slow decay scintillator. A fast decay sensor/scintillator 416 coupled to a second photodiode 417, are placed adjacent to and in close proximity to scintillator 411 and photodiode 412, respectively, in the path of the radiation beam 413. In an embodiment, a distance between the scintillator 416 and the scintillator 411 may vary as long as both the scintillators remain in the path of the radiation beam 413. The radiation detected by both the scintillator-photodetector pairs 411/412 and 416/417 is converted to an electrical signal using an electrical circuit on a PCB 415 coupled to both scintillator-photodetector pairs. An electronic mechanism 418 is provided to turn on the radiation source 414 to expose the scintillators 411 and 416 to stimulating radiation 413, or to turn off the radiation source 414 to stop stimulating radiation 413 and measure the afterglow. Once the radiation source 414 is turned off, the fast decay sensor 416 tracks the radiation source 414 as it falls, while the slow decay scintillator 411 lags behind in detection. In one embodiment, after the full cessation of stimulating radiation is determined by fast decay sensor 416, the afterglow of the slow decay sensor/scintillator 416 is calculated.

In various embodiments the planar configuration shown in FIG. 4B requires a wider angle radiation beam and larger footprint compared to the columnar configuration shown in FIG. 4A which requires a narrower radiation beam and a relatively smaller footprint. In the planar configuration shown in FIG. 4B, the fast sensor 416 receives the radiation beam 413 from the radiation source 414 and attenuates the beam whereas in the columnar configuration shown in FIG. 4A the beam is attenuated by the slow decay scintillator, photodiode and the PCB before being received by the fast decay scintillator.

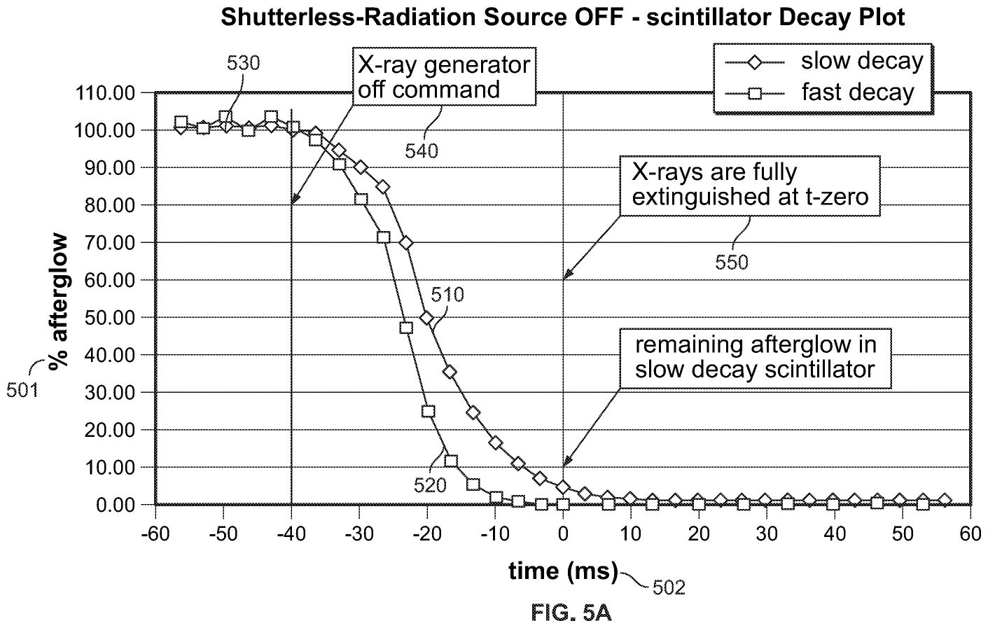

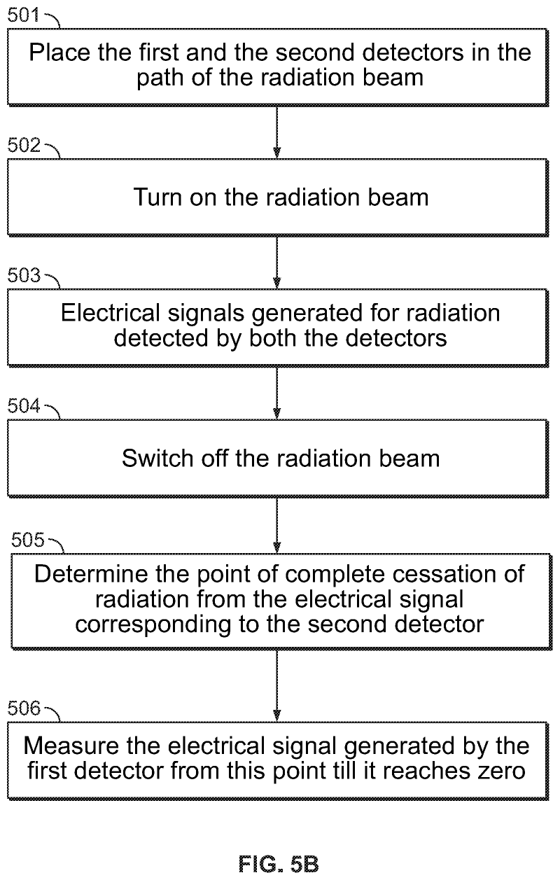

FIG. 5 illustrates a mechanism of afterglow detection using a combination of slow and fast decay detectors (scintillator-photodiode pairs, coupled to a PCB), by means of a scintillator decay plot. Referring to FIG. 5, curve 510 represents afterglow 501 as percentage of radiation versus time 502 for a slow decay scintillator, while curve 520 represents the same for a fast decay scintillator. At point 530 in the plot, when the radiation source is on, the percentage afterglow is 100%. At point 540, the radiation source is turned off electronically, and thereafter both the scintillator detectors start showing decay in detected radiation. At point 550, radiation is completely extinguished, as shown by the curve 520 for the fast decay detector. However, the slow decay detector still shows an afterglow at this point, as can be seen in curve 510. This afterglow, exhibited after complete cessation of radiation, can thus be measured for the scintillator. It should be noted that at some point in time, the ionized radiation levels reach zero. This can be tracked by using the fast decay detector to look for a near zero signal, which is typically on the order of less than 0.2% of the light signal intensity and indicative of a complete cessation of radiation.

FIG. 5B is a flowchart illustrating a method for measuring afterglow for a scintillator, with reference to the embodiments described in FIGS. 4A, 4B and 5A. Referring to FIG. 5B, at step 501, a first detector comprising both a first scintillator, which, in an embodiment is a slow decay scintillator and a first photodiode coupled to the first scintillator and a second detector comprising both a second scintillator/sensor, which, in an embodiment is a fast decay scintillator and a second photodiode coupled the second scintillator, are placed in the path of the radiation beam emitted by a radiation source. At step 502, a radiation beam is activated by an electronic mechanism, which in an embodiment, may comprise an electronic signal such as, but not limited to, a transistor-transistor logic (TTL) signal generated by a software algorithm and controlled by a signal controller for turning the source 404 on or off. The incident radiation is detected by both the first and the second detectors and a corresponding electrical signal is generated for each of the detectors, at step 503. The radiation source is switched off by the electronic mechanism, at step 504. In an embodiment, the radiation source is switched on for a duration ranging from 0.1 to 30 seconds. In various embodiments, the radiation source is switched on for a duration that is dependent upon the slow decay scintillator type and formulation. In addition, the afterglow behavior varies based upon the duration of radiation exposure; thus, the duration maybe determined by using datasheets, measurement and empirical data of the scintillator. In an embodiment, the duration of radiation exposure is determined as an empirical value ranging from 3 seconds to 30 seconds. Thereafter, at step 505, the electrical signal corresponding to the second detector, which comprises the fast decay scintillator, is used to determine the point of complete cessation of radiation. This is the point where the electrical signal from the fast decay scintillator drops to nearly zero, as shown in FIG. 5A. From this point of complete cessation of radiation as shown by the second detector, the electrical signal generated by the first detector is measured, at step 506. This measured electrical signal represents the afterglow radiation for the slow decay scintillator. Measurement ends when the first detector, comprising the slow decay scintillator, also shows complete cessation of radiation, that is, the electrical signal from the first detector decays towards zero afterglow.

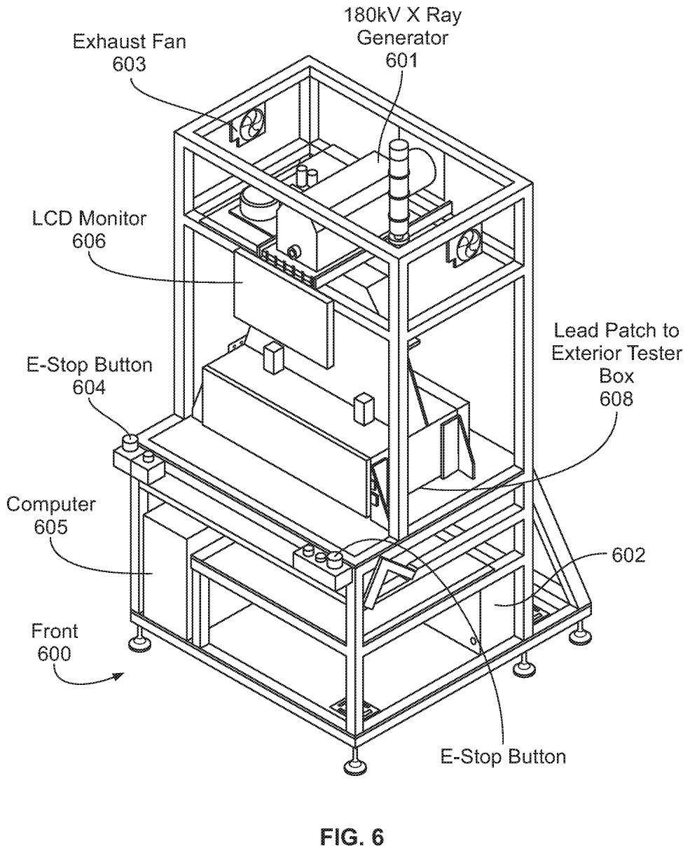

FIG. 6 illustrates a system assembly for measuring afterglow, in accordance with an embodiment of the present specification. Referring to FIG. 6, system assembly 600 comprises a radiation source 601, such as a 180 kV X-ray generator and a tester box 602 comprising the scintillator to be tested. In embodiments, radiation source 601 comprises an X-ray generator having an energy ranging from 50 kV to 300 kV and power ranging from 0.5 mA to 10 mA. In one embodiment, the tester box 602 is encased in lead 608. An exhaust fan 603 may be provided close to the radiation source 601 to keep the system assembly 600 cool. The electronic on/off mechanism for the radiation source 601 for the purpose of afterglow measurement comprises an electronic switch 604, which sends a command to a computer 605, which in turn controls the system assembly 600. A display 606, such as an LCD monitor, is also provided for presenting the status of the system 600 in real time to a user or operator. Operationally, the user uses the switch 604 to turn on the radiation source 601 to expose the scintillator in the tester box 602 to stimulating radiation, or to turn off the radiation source 601 to stop stimulating radiation and measure the afterglow. The radiation source 601 is controlled by the computer 605, which accepts the ON/OFF command from the user via the electronic switch 604.

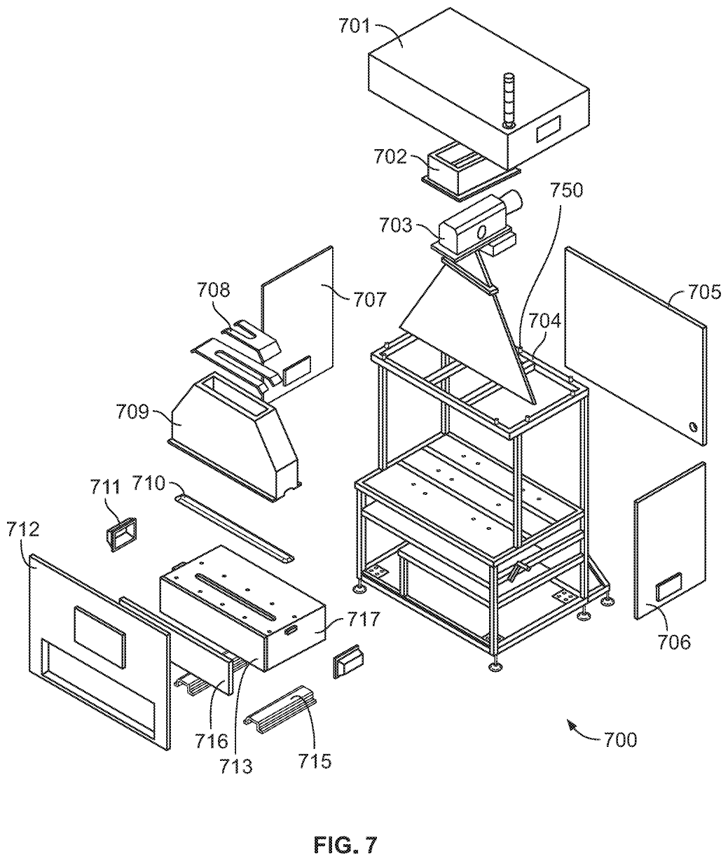

FIG. 7a illustrates an exploded, break-away view of the system assembly for measuring afterglow shown in FIG. 6, in accordance with one embodiment of the present specification. Referring to FIG. 7, system 700 comprises a housing 750 for the system components. In one embodiment, the housing 750 comprises a main frame 704, a top panel 701, a rear panel 705, a front panel 712 and two side panels 706 and 707. Within the housing 750, the system further comprises a radiation source 703, such as a 180 kV X-ray generator and a detector test fixture 713 comprising the scintillator to be tested. In embodiments, radiation source 703 comprises an X-ray generator having an energy ranging from 50 kV to 300 kV and power ranging from 0.5 mA to 10 mA. In one embodiment, the detector test fixture 713 is a test box 717 encased in lead. In one embodiment, a supporting bracket 715 and a lead door 716 is provided for the test box 717. In one embodiment, the housing also comprises a separate frame 702 for the radiation source 703. In one embodiment, a collimator is provided for directing the radiation beam from the source to the scintillator detector. In one embodiment, the collimator is encased in a box 709 comprising a top cover 708, a bar 710 and a side cover 711.

As is known, visible light photons emitted by a scintillator in response to stimulating radiation or by recombination of hole-electron pairs, are absorbed by a photodiode coupled with the scintillator and converted into electrons resulting in a current flow. When the stimulating radiation, which in an embodiment is a beam of X-rays, is turned off, the light output of the scintillator decays in two phases, wherein phase one corresponds to a fast decay and phase two corresponds to a slow decay. An intensity (or number) of light photons emitted by the scintillator in the two exponentially decaying phases may be obtained by the following equation:

N=Lf*e\hat{ }(−t/τf)+Ls*e\hat{ }(−t/τs) (1)

where N represents the number of light photons or intensity of light; τf and τs are the fast and slow decay time constants respectively; Lf represents an initial full intensity of the scintillator before the termination of X-rays and Ls represents an initial intensity of afterglow at a start of the slow decay phase.

The first decay phase (fast decay) comprises a rapid drop of signal intensity from a full light output intensity to a low light output intensity, whereby the low light output intensity is on the order of less than 3% of the full light output intensity. A decay time of the fast decay phase is measured from the instance of time the stimulating radiation is turned off to the instance of time when the light output intensity reaches e\hat{ }(−1) of the full light output intensity Lf. The fast/primary decay time may vary from multiples of 10 nanoseconds to multiples of 10 microseconds. The second decay phase (slow decay) begins after the first, fast decay phase and is known as the afterglow. The second, slow decay phase is the result of trapped holes and electrons in crystalline defects or impurities of the scintillator that are released and recombined, thus emitting photons. The rate of release of holes and electrons from the scintillator is dependent on a thermalization rate in the scintillator.

In an embodiment of the present specification, the afterglow is measured as percentage of incident stimulating radiation by using the following equation:

A(t)=100*(I(t)−Idark)/(Ilight−Idark) (2)

where A(t) represents afterglow intensity at a time t; I(t) represents a light current measured at the time t; Idark represents a current measured at the scintillator before the stimulating radiation (X rays) is turned on; and Ilight represents the current measured at the scintillator corresponding to a full intensity of light while stimulating radiation, in other words, when the X-rays are turned on or being emitted.

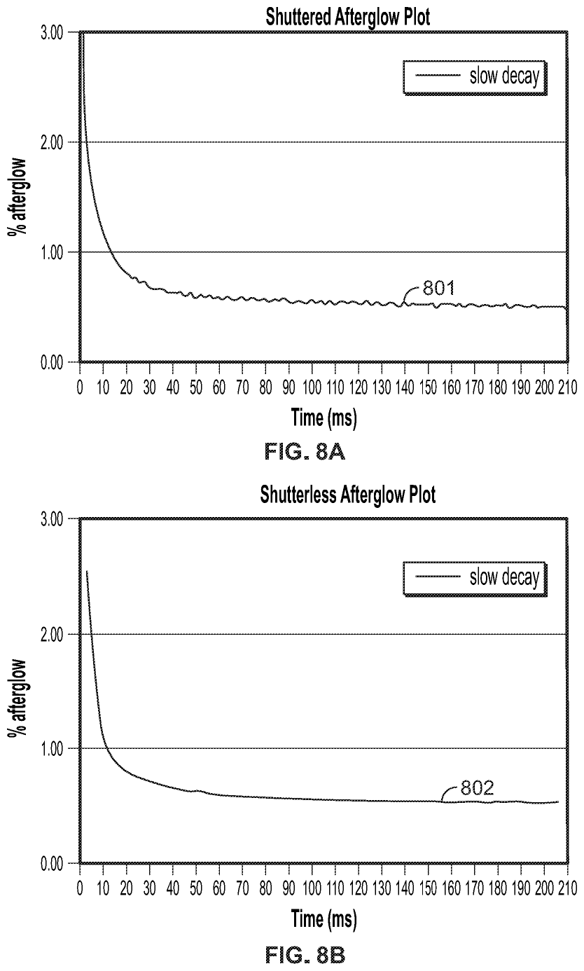

FIGS. 8A and 8B present a side by side comparison of plots generated by using the prior art method of using a shutter for afterglow measurement and by the present shutter-less method for the same. Referring to FIGS. 8A and 8B, plots 801 and 802 illustrate the decay curves for a slow decay scintillator representing afterglow levels versus time, with prior art shutter method and with the present shutter-less method, respectively. As can be seen from the figures, the two curves 801 and 802 are very similar. This illustrates that the method and system of present specification produces results with similar accuracy as prior art.

One of ordinary skill in the art would appreciate that the present method for afterglow measurement may be applied to any kind of inorganic scintillators including, but not limited to, BaF or barium fluoride; BGO or bismuth germinate; CdWO4 or cadmium tungstate; CaF2(Eu) or calcium fluoride doped with europium; CaWO4 or calcium tungstate; CsI: undoped cesium iodide; CsI(Na) or cesium iodide doped with sodium; CsI(Tl) or cesium iodide doped with thallium; Gd2O2S or gadolinium; LaBr3(Ce) (or lanthanum bromide doped with cerium); LaCl3(Ce) (or lanthanum chloride doped with cerium3(Ce); PbWO4 or lead tungstate; LuI3 or lutetium iodide; LSO or lutetium oxyorthosilicate (Lu2SiO5); LYSO (Lu1.8Y0.2SiO5(Ce)); YAG(Ce) or yttrium aluminum garnet; ZnS(Ag) or zinc sulfide and ZnWO4 or zinc tungstate, which is similar to CdWO.

In an embodiment, the present system and method of afterglow measurements may be used to calibrate and normalize raw scanned image data to produce an enhanced image in scanning systems. For this purpose, acceptable afterglow limits at specific decay time constants are specified for a given scanning system. In various embodiments, if no object is placed in the path of the radiation beam produced by an X-ray source, during a scan, the radiation source may be turned on/off for measuring the unobstructed light level, and dark level including the afterglow. By using the measured afterglow, the scanning system may be calibrated and the raw scanned image data may be normalized for obtaining scanned images of enhanced quality. At the production level, detectors may be tested and screened for the specified limits, using the present afterglow measurement system. In embodiments, the radiation source is turned on to measure a full intensity of an unobstructed light level and then is turned off to measure a dark intensity which includes the afterglow and a photodiode dark current. Subsequently, the measured signal is normalized by subtracting the dark signal intensity from the unobstructed light signal intensity. The normalized signal represents the full (100%) light signal intensity.

In another application, an afterglow percentage is determined for a given scanning system using the methods of present specification. These measured levels may be compensated in-situ with the detectors remaining in place in the scanning system; or in-process during the operation of the scanning system in real time. In embodiments, normalization may be applied at the time of image generation by the scanning system software.

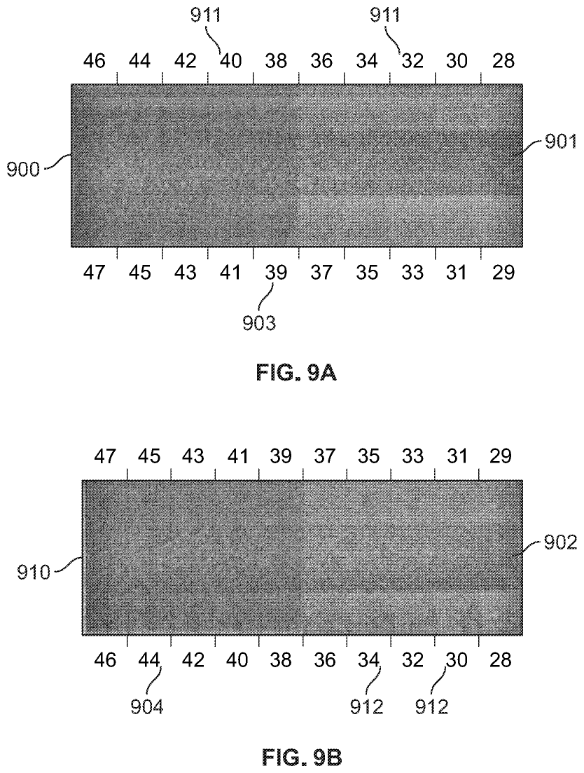

In embodiments, by compensating for the measured levels of afterglow, an enhancement is observed in the resolution and contrast characteristics of the image, otherwise, the afterglow may hide some features of the object being scanned. In an embodiment, compensating for the measured levels of afterglow comprises normalizing the measured signal by subtracting the dark signal intensity from the unobstructed light signal intensity, as explained above. Smears or streaks in the edges of a scanned image are caused by afterglow and by removing the afterglow these artifacts are tuned out, thus rendering a sharper and clearer image. In most scanning systems, calibration or normalization is performed at startup and before scanning images, in order to correct for too less or too much light and for different materials with various attenuations and to compensate for non-linearity. This calibration may also incorporate adjustments on account of afterglow. This normalization may be periodically determined and executed by the system software. As an example, FIGS. 9A and 9B show the effect of afterglow on the penetration test conducted with a scanning system in exemplary images. In this test, a piece of lead material is hidden under a step wedge steel and scanned using radiation from the scanning system.

Referring to FIGS. 9A and 9B, the dark bands 901 and 902 represent the lead material in the images 900 and 910 respectively. The numbers 911, 912 on top and bottom of each image indicate the thickness of steel under which the lead material 901, 902 is hidden. As can be seen in FIG. 9A, which illustrates an image generated when the afterglow is above the specified limits, the dark band 901 disappears at approximately 39 mm thickness, shown as 903. Referring to FIG. 9B, which illustrates an image generated when the afterglow is within the specified limits, the dark band 902 is still visible near 44 mm thickness 904.

This effect of afterglow can be accurately measured using the present method and can be calibrated into the system software to remove errors in image generation. In embodiments, the radiation source is turned on to measure a full intensity of unobstructed light level and then is turned off to measure a dark intensity which includes the afterglow and a photodiode dark current. In embodiments, by compensating for the measured levels of afterglow, image resolution and contrast are enhanced. In an embodiment, compensating for the measured levels of afterglow comprises normalizing the measured signal by subtracting the dark signal intensity from the unobstructed light signal intensity, as explained above. Once the level of afterglow at different time constants is determined, the afterglow may be removed from the image data using a predefined algorithm in order to produce sharper images. Each pixel of the scintillation detector of the scanning system outputs a light signal that may be calibrated to remove the afterglow signal from the light signal that is detected while the object is scanned.

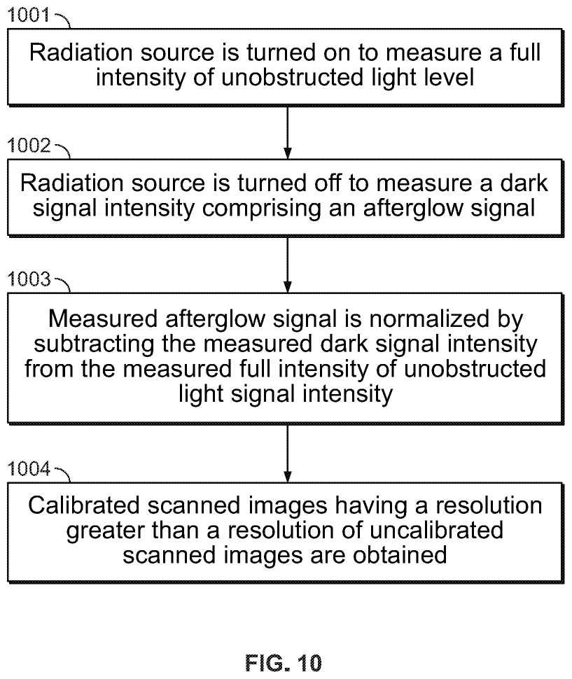

FIG. 10 is a flowchart illustrating a method of calibrating a scanned image by calibrating afterglow measurement data of the scanned image, in an embodiment of the present specification. In embodiments, the method of the present specification is used for calibrating scanned images of an object being scanned by using a scanning system comprising at least a radiation source and a detector, wherein, as explained above, the detector comprises at least a fast scintillator coupled with a photodiode. At step 1001 the radiation source is turned on to measure a full intensity of unobstructed light level detected by the detector. At step 1002 the radiation source is turned off to measure a dark signal intensity comprising an afterglow signal detected by the detector. In embodiments, the dark signal intensity comprises a photodiode dark current. At step 1003 the measured afterglow signal is normalized by subtracting the measured dark signal intensity from the measured full intensity of unobstructed light signal intensity. At step 1004 calibrated scanned images having a resolution greater than a resolution of uncalibrated scanned images, are obtained.

In one embodiment, the method of present specification may be incorporated in a software implementation on the same afterglow measurement system that uses a mechanical shutter for measurement. In an embodiment, where the method of present specification is implemented in a measurement system that uses a mechanical shutter for measurement, the X-ray source is turned on for a predetermined amount of time before opening the mechanical shutter. The X-ray source is turned off only after the mechanical shutter is closed. In an embodiment, the X-ray source is turned on at least two seconds before opening the mechanical shutter.

In this manner, the same system may be used with or without shutter, with the present method providing a backup mechanism in case the shutter mechanism fails.

The above examples are merely illustrative of the many applications of the system of present specification. It should be also understood by those of ordinary skill in the art that while the present system is described with respect to X-ray scanning systems, the afterglow measurement method and system of the present specification may be implemented for low, medium or high-energy X-rays, gamma rays, neutrons or other type of radiation.

The above examples are merely illustrative of the many applications of the system of present specification. Although only a few embodiments of the present invention have been described herein, it should be understood that the present invention might be embodied in many other specific forms without departing from the spirit or scope of the invention. Therefore, the present examples and embodiments are to be considered as illustrative and not restrictive, and the invention may be modified within the scope of the appended claims.

We claim:

1. A method for measuring radiation afterglow for a first detector comprising a slow decay scintillator coupled to a first photodiode, said method comprising:
providing a second detector comprising a fast decay scintillator coupled to a second photodiode;
placing said first and said second detectors in the path of a radiation beam generated by a radiation source;
using electronic means for switching on said radiation source;
using an electrical circuit in contact with said first and said second detectors to produce a first and a second electrical signal corresponding to the detected radiation;
using electronic means for switching off said radiation source;
determining a first point in time when the second detector comprising said fast decay scintillator detects complete cessation of radiation; and
measuring the detected radiation level for the first detector comprising said slow decay scintillator from said first point in time till the point in time when said first detector detects complete cessation of radiation.

2. The method of claim 1, wherein the radiation source is turned on for a time duration ranging from 0.1 to 30 seconds.

3. The method of claim 1, wherein a duration for which the radiation source is turned on is dependent upon the slow decay scintillator's fast and slow decay time constants.

4. The method of claim 1, wherein a duration for which the radiation source is turned on is dependent upon the slow decay scintillator's type and formulation.

5. The method of claim 1, wherein said slow decay scintillator in said first detector exhibits 10% afterglow in a response time ranging from 0.1 to 10 ms.

6. The method of claim 1, wherein said fast decay scintillator in said second detector exhibits 10% afterglow in a response time ranging from 0.1 to 10 ms.

7. The method of claim 1, wherein the complete cessation of radiation is determined from the electrical signals generated by the corresponding detectors.

8. The method of claim 7 wherein an electrical circuit in contact with said first and said second detectors produces the first electrical signal and a second electrical signal corresponding to the detected radiation respectively.

9. A system for measuring radiation afterglow for a first detector comprising a slow decay scintillator coupled to a first photodiode, the system comprising:
a second detector comprising a fast decay scintillator coupled to a second photodiode;
a radiation source for generating a radiation beam which irradiates said first and said second detectors;
electronic means for switching the said radiation source on or off;
an electrical circuit in contact with said first and said second detectors to produce a first electrical signal and a second electrical signal corresponding to the detected radiation; and
measurement means for measuring the first electrical signal for said first detector from the point in time when the second detector detects complete cessation of radiation till the point in time when said first detector detects complete cessation of radiation.

10. The system of claim 9 wherein the measured first electrical signal is used for obtaining the radiation afterglow for the first detector.

11. The system of claim 9 wherein the electrical circuit in contact with said first and said second detectors is provided on a circuit board having a first top side in contact with the first detector and a second opposing bottom side in contact with the second detector.

12. The system of claim 11 wherein the radiation beam passes through the circuit board to irradiate the second detector.

13. The system of claim 9, wherein a duration for which the radiation source is turned on is dependent upon the slow decay scintillator's fast and slow decay time constants.

14. The system of claim 9, wherein a duration for which the radiation source is turned on is dependent upon the slow decay scintillator's type and formulation.

15. The system of claim 9, wherein the radiation source is turned on for a time duration ranging from 0.1 to 30 seconds

16. The system of claim 9, wherein said slow decay scintillator in said first detector exhibits 10% afterglow in a response time ranging from 0.1 to 10 ms.

17. The system of claim 9, wherein said fast decay scintillator in said second detector exhibits 1% afterglow in a response time ranging from 0.1 to 10 ms.

18. The system of claim 9, wherein the complete cessation of radiation is determined from the electrical signals generated by the corresponding detectors.

19. The system of claim 9, wherein the second detector is positioned below the first detector in a funnel configuration.

20. The system of claim 9, wherein the second detector is positioned at a side of the first detector in a parallel configuration.

21. A method of calibrating scan images of an object being scanned by using a scanning system comprising at least a radiation source and a detector, the detector comprising a fast scintillator coupled with a photodiode, the method comprising:
turning on the radiation source to measure a full intensity of unobstructed light level detected by the detector;
turning off the radiation source to measure a dark signal intensity comprising an afterglow signal detected by the detector;
normalizing the measured afterglow signal by subtracting the measured dark signal intensity from the measured full intensity of unobstructed light signal intensity; and,
obtaining calibrated scan images.

22. The method of claim 21 wherein the calibrated scan images have a resolution greater than a resolution of uncalibrated scan images.

23. The method of claim 21 wherein the radiation source has an energy ranging from 50 kV to 300 kV and power ranging from 0.5 mA to 10 mA.

24. The method of claim 21 wherein the dark signal intensity comprises a photodiode dark current.

25. The method of claim 21 wherein normalizing the measured afterglow signal is performed in-situ with the detectors remaining in place in the scanning system;

26. The method of claim 21 wherein normalizing the measured afterglow signal is performed in-process during the operation of the scanning system in real time.

27. The method of claim 21 wherein the calibrated scanned images have a greater contrast characteristic than a contrast characteristic of uncalibrated scanned images.
